(19) United States
(12) Patent Application Publication
(10) Pub. No.: US 2009/0251640 A1
(43) Pub. Date: Oct. 8, 2009

(54) LIQUID CRYSTAL DISPLAY

(75) Inventors: Ya-Ling Hsu, Hsinchu (TW); Chun-Chieh Wang, Hsinchu (TW); Chun-Liang Lin, Hsinchu (TW); Chen-Hsien Liao, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: AU OPTRONICS CORPORATION, Hsinchu (TW)

(21) Appl. No.: 12/177,162

(22) Filed: Jul. 22, 2008

(30) Foreign Application Priority Data
Apr. 3, 2008 (TW) 97112285

(51) Int. Cl. G02F 1/13357

(52) U.S. Cl. 349/69; 349/61

(57) ABSTRACT

A liquid crystal display (LCD) including a backlight module and an LCD panel is provided. The backlight module has at least one white light source. A light-emitting spectrum of the backlight module has a relative maximum brightness peak value between wavelengths of 430 nm and 470 nm and between wavelengths of 520 nm and 620 nm respectively. The LCD panel disposed above the backlight module includes a plurality of substrates and a liquid crystal layer located there-between. One of the substrates has a red filter layer, a green filter layer, and a blue filter layer. Specially, Rx and Ry respectively represent an x coordinate and a y coordinate of the red filter layer in a CIE 1931 chromaticity diagram under a CIE standard light source C, where Rx≧0.65 and Ry≦0.32.

### CROSS-REFERENCE TO RELATED APPLICATION

This application claims the priority benefit of Taiwan application serial no. 97112285, filed on Apr. 3, 2008. The entirety of the above-mentioned patent application is hereby incorporated by reference herein and made a part of specification.

### BACKGROUND OF THE INVENTION

1. Field of the Invention

The present invention generally relates to a display, in particular, to a liquid crystal display (LCD).

2. Description of Related Art

Liquid crystal display (LCD) having such advantages as high image quality, efficient space utilization, low power consumption, and no radiation, has become the mainstream in the display market. With the popularization of the LCD, one of the key indexes in purchasing an LCD is high color reproduction. Currently, several high color reproduction techniques are provided to meet the consumers' demand on high color reproduction.

An LCD mainly includes an LCD panel and a backlight module providing a light source for the LCD panel. The LCD panel includes, for example, an active device array substrate, a color filter substrate, and a liquid crystal layer disposed there-between. The color filter substrate has a red filter layer, a green filter layer, and a blue filter layer. Generally, the light source in the backlight module may be a cold-cathode fluorescent lamp (CCFL), a light-emitting diode (LED), or other types of light sources.

For LCD color performance, the color saturation of a display is usually evaluated by standards constituted by National Television System Committee (NTSC). Further, when adjusting a red saturation, a green saturation, and a blue saturation of an LCD, those of ordinary skill in the art generally adopt the sRGB or EBU specification as a reference for color adjustment. According to the sRGB specification, a red specification (Rx, Ry)=(0.640, 0.330), a green specification (Gx, Gy)=(0.300, 0.600), and a blue specification (Bx, By)=(0.150, 0.060) respectively represent a red coordinate, a green coordinate, and a blue coordinate in CIE 1931.

In the development of high color saturation techniques, the type of the backlight module is quite important, and the white LED is the most popular at present. The white LED advantageous in being power-saving, durable, non-toxic, and having quick response, small size, and simple structure has already been widely applied to portable backlight modules. Currently, in the white LEDs serving as backlight modules and widely used in the market, one is formed by a blue LED combined with a yellow fluorescent powder to emit a white light.

FIG. 1 is a CIE 1931 chromaticity diagram of a conventional LCD. Referring to FIG. 1, a white light provided by a backlight module in the LCD 10 is formed by a blue LED combined with a yellow fluorescent powder. As shown in FIG. 1, a red performance of the LCD 10 still has a certain distance from the red coordinate on the sRGB specification, so the light source formed by a blue LED together with a yellow fluorescent powder has poor color rendering index. More particularly, the red performance of the LCD 10 has an orange cast, such that a red saturation performance of the LCD 10 is undesired, thus affecting the entire color display performance of the LCD 10.

### SUMMARY OF THE INVENTION

Accordingly, the present invention is directed to an LCD capable of improving the red saturation, so as to eliminate the disadvantage that the red performance of the display frame has an orange cast.

An LCD including a backlight module and an LCD panel is provided. The backlight module has at least one white light source. A light-emitting spectrum of the backlight module has a relative maximum brightness peak value between wavelengths of 430 nm and 470 nm and between wavelengths of 520 nm and 620 nm respectively. The LCD panel disposed above the backlight module includes a plurality of substrates and a liquid crystal layer located there-between. One of the substrates has a red filter layer, a green filter layer, and a blue filter layer. Specially, Rx and Ry respectively represent an x coordinate and a y coordinate of the red filter layer in a CIE 1931 chromaticity diagram under a CIE standard light source C, where Rx≧0.65 and Ry≦0.32.

In an embodiment of the present invention, the white light source is an LED. In an embodiment, the LED includes a blue diode and a fluorescent powder material distributed on the inner wall of the blue diode.

In an embodiment of the present invention, a transmittance of the red filter layer in a yellow wave band is substantially smaller than or equal to 40%. In an embodiment, a wavelength of the yellow wave band is substantially between 585 nm and 605 nm, and in another embodiment, the yellow wave band is substantially 595 nm.

In an embodiment of the present invention, the transmittance of the red filter layer in the yellow wave band is substantially greater than or equal to 30%.

In an embodiment of the present invention, the backlight module is a direct or edge type backlight module.

In an embodiment of the present invention, the composition of the red filter layer comprising three pigments of PR254, PR177, and PY150.

In an embodiment of the present invention, the LCD is suitable for displaying a red frame, and Ry′ represents a y coordinate of the red frame in the CIE 1931 chromaticity diagram, where Ry′≦0.335.

In view of the above, in the LCD of the present invention, through controlling the relative maximum brightness peak values distributed in the light-emitting spectrum of the backlight module and a color filter layer satisfying specific relations on the CIE chromaticity diagram is adopted to improve the red saturation of the LCD, so as to eliminate the problem that the red performance of the display frame has an orange cast.

In order to make the aforementioned and other objectives, features, and advantages of the present invention comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a CIE 1931 chromaticity diagram of a conventional LCD.

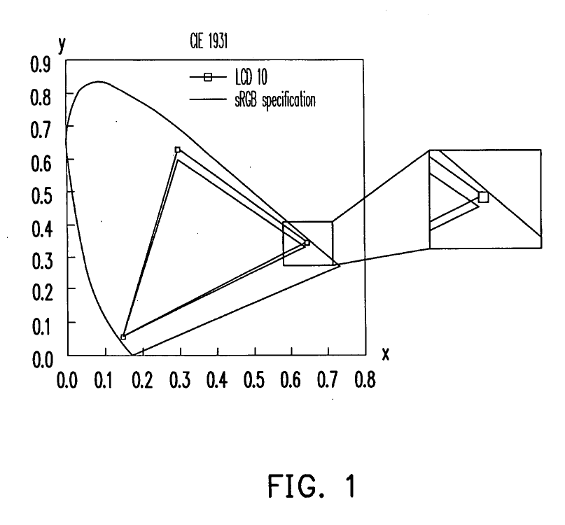

FIG. 2 is a schematic view of an LCD according to an embodiment of the present invention.

FIG. 3 is a schematic view showing a light-emitting spectrum of a backlight module and a transmittance spectrum of a red filter layer in an LCD according to an embodiment of the present invention.

FIG. 4 is a CIE 1931 chromaticity diagram showing the comparison between the LCD of the present invention and the conventional LCD.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

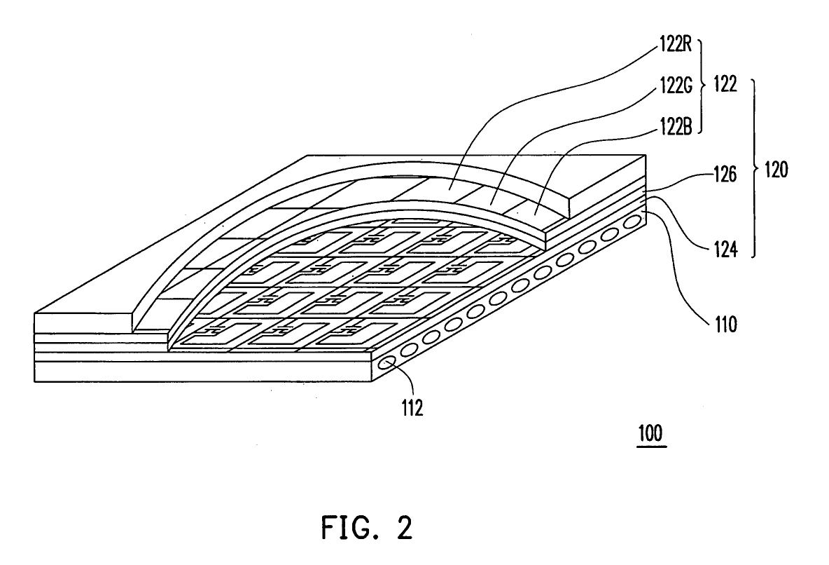

FIG. 2 is a schematic view of an LCD according to an embodiment of the present invention. Referring to FIG. 2, the LCD 100 includes a backlight module 110 and an LCD panel 120. The backlight module 110 is, for example, a direct or edge type backlight module. Further, the backlight module 110 has at least one white light source 112, and the lights emitted by the white light source 112 are suitable to be provided for the LCD panel 120. In this embodiment, the white light source 112 is, for example, an LED capable of providing white lights.

Referring to FIG. 2, the LCD panel 120 is disposed above the backlight module 110. The LCD panel 120 is mainly formed by two substrates and a liquid crystal layer 126 located there-between. As shown in FIG. 2, the two substrates may be respectively a thin film transistor array substrate 124 and a color filter substrate 122. The color filter substrate 122 has a red filter layer 122R, a green filter layer 122G, and a blue filter layer 122B. Of course, in other embodiments, the two substrates may also be a color filter on array (COA) substrate and an opposite substrate having a common electrode, or an array on color filter (AOC) substrate and an opposite substrate having a common electrode, respectively.

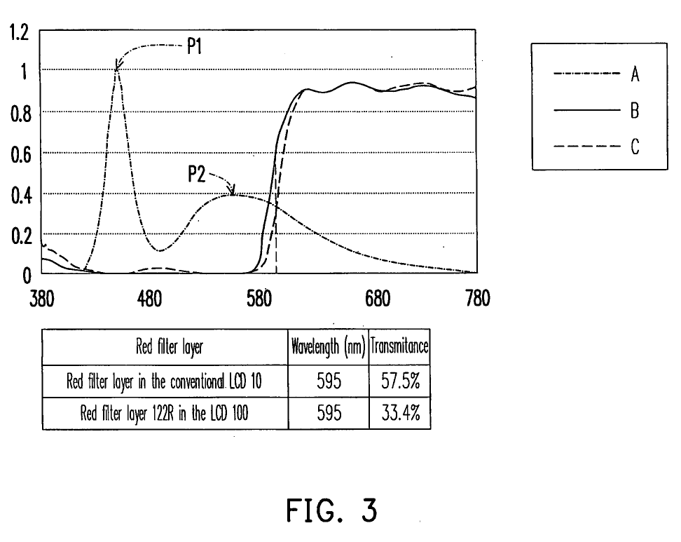

FIG. 3 is a schematic view showing a light-emitting spectrum of a backlight module and a transmittance spectrum of a red filter layer in an LCD according to an embodiment of the present invention. Referring to FIG. 3, the spectrum A is a light-emitting spectrum of the backlight module 110, and has a relative maximum brightness peak value between wavelengths of 430 nm and 470 nm and between wavelengths of 520 nm and 620 nm respectively, for example, P1 and P2 in the spectrum A in the figure. In particular, the inner wall of the white light source 112 is distributed with various kinds of fluorescent powder materials for adjusting the brightness, chromaticity, and other optical properties of the white light source. In this embodiment, the white light source providing the light-emitting spectrum is, for example, formed by a blue diode together with an appropriate fluorescent powder material. The fluorescent powder material is, for example, a yellow fluorescent powder.

It should be noted that, the backlight module 110 having the above light-emitting spectrum goes with the red filter layer 122R having an appropriate color performance, so as to effectively solve the problem of poor red performance of the conventional LCD 10. In particular, when the red filter layer 122R of this embodiment is measured by a standard illuminant (C light source) set up by the International Commission on Illumination (CIE), the red filter layer 122R satisfies the following relational expressions: Rx≧0.65 and Ry≦0.32. Here, Rx and Ry are respectively defined as an x coordinate and a y coordinate of the red filter layer 122R in a CIE 1931 chromaticity diagram under the C light source.

Referring to FIG. 3, in this embodiment, a transmittance T of the red filter layer 122R in a yellow wave band satisfies, for example but not limited to, a relational expression of 30%≦T≦40%. In detail, the wavelength of the yellow wave band is, for example, between 585 nm and 605 nm. In this embodiment, the transmittance T of the red filter layer 122R is calculated by taking 595 nm as an example for comparing with the conventional art. A spectrum B is a transmittance spectrum of the red filter layer in the conventional LCD 10 under the C light source, and a spectrum C is a transmittance spectrum of the red filter layer 122R of the present invention under the C light source. Seen from the figure, the transmittance of the red filter layer 122R of the conventional LCD 10 at the wavelength of 595 nm is approximately 57.5%, and the transmittance of the red filter layer 122R of the present invention at the wavelength of 595 nm is approximately 33.4%. In other words, when the transmittance of lights at the boundary of a red wave band after passing through the red filter layer 122R is smaller than a specific value, the red saturation of the lights passing through the LCD 100 can be greatly improved, and the transmittance of the LCD 100 is maintained at a certain degree. Thereby, the red performance of the LCD 100 can be significantly enhanced under a circumstance that the brightness thereof is slightly changed.

It should be noted that, in practice, during the fabrication of the red filter layer 122R satisfying the above conditions, three pigments of PR254, PR177, and PY150 may be adopted. Of course, the material of the red filter layer 122R can be prepared by other materials, and the present invention is not limited herein. In addition, the pigment numbers PR254, PR177, and PY150 are international standard material numbers used in the field.

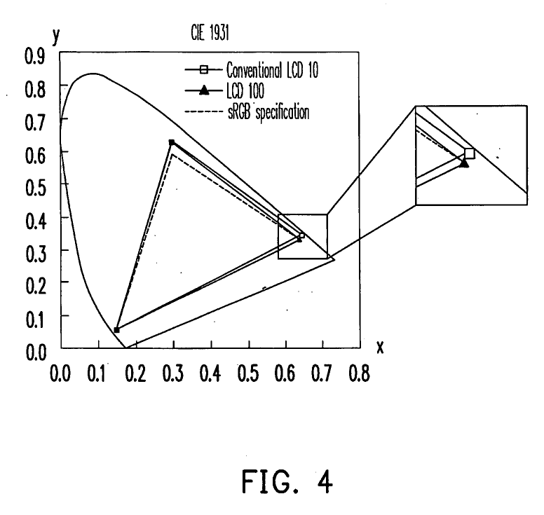

FIG. 4 is a CIE 1931 chromaticity diagram showing the comparison between the LCD of the present invention and the conventional LCD. Referring to FIG. 4, the conventional LCD 10 is apparently different from the LCD 100 of this embodiment on the red saturation in the CIE-1931 chromaticity diagram. In detail, the light-emitting spectrum of the backlight module 110 in the LCD 100 has the relative maximum brightness peak values P1 and P2 between the wavelengths of 430 nm and 470 nm and between the wavelengths of 520 nm and 620 nm respectively (as shown in FIG. 3). In the present invention, for example, the transmittance of the red filter layer 122R at the boundary of the red wave band is controlled, and the LCD panel 120 having the red filter layer 122R satisfying Rx≧0.65 and Ry≦0.32 goes with the backlight module 110. Thereby, the light source provided by the backlight module 110 may achieve a high color saturation performance, especially an excellent red saturation performance, when passing through the LCD panel 120. Some data will be given below to help illustrate the color performance of the LCD 100.

TABLE 1

| | Red Filter Layer | | Red Frame of LCD 100 | |
|---|---|---|---|---|
| CIE Chromaticity Diagram | Rx | Ry | Rx′ | Ry′ |
| Conventional LCD 10 | 0.660 | 0.330 | 0.646 | 0.343 |
| LCD 100 | 0.657 | 0.320 | 0.644 | 0.333 |

In particular, Table 1 shows chromaticity coordinates actually measured for the conventional LCD 10 and the LCD 100 of this embodiment. Referring to Table 1, in the CIE chromaticity diagram, a chromaticity coordinate (Rx, Ry) of the red filter layer adopted by the conventional LCD 10 is, for example, (0.660, 0.330), and a chromaticity coordinate (Rx, Ry) of the red filter layer 122R adopted by the LCD 100 in an embodiment of the present invention is, for example, (0.657, 0.320). In the present invention, the LCD panel 120 having the red filter layer 122R satisfying the above condition is employed and goes with the backlight module 110 having the relative maximum brightness peak values P1 and P2. Thereby, the entire color performance of the LCD 100 is optimized, and the red saturation performance thereof further approaches to the red specification in the sRGB specification, so as to effectively solve the problem that the red performance of the conventional LCD 10 has an orange cast during display.

Together referring to FIG. 4 and Table 1, when the LCD 100 displays a red frame, the chromaticity coordinate (Rx′, Ry′) of the red frame in the CIE 1931 chromaticity diagram is approximately (0.644, 0.333), which is closer to the red specification (Rx, Ry)=(0.640, 0.330) in the sRGB specification, compared with the red chromaticity coordinate (Rx′, Ry′)=(0.646, 0.343) of the conventional LCD 10. In other words, when the backlight module 110 and the LCD panel 120 satisfying the above particular relational expression are together adopted, the color performance of the LCD 100 can be improved. Thereby, the problem of poor color saturation of the LCD 100 in displaying red frame can be effectively solved, thus improving the display quality of the LCD 100.

In view of the above, when adjusting the entire color saturation of the LCD, the light-emitting spectrum distribution of the backlight module and the corresponding color performance of the red filter layer should be both considered, so as to effectively solve the problem that the red performance has an orange cast. As such, the color saturation of each color may not interfere with each other, and the entire color saturation of the LCD can be effectively improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A liquid crystal display (LCD), comprising:
a backlight module, provided with at least one white light source, wherein a light-emitting spectrum of the backlight module comprises a relative maximum brightness peak value between wavelengths of 430 nm and 470 nm and between wavelengths of 520 nm and 620 nm respectively; and
an LCD panel, disposed above the backlight module, and provided with a plurality of substrates and a liquid crystal layer located there-between, wherein one of the substrates comprises a red filter layer, a green filter layer, and a blue filter layer, and Rx and Ry respectively represent an x coordinate and a y coordinate of the red filter layer in a CIE 1931 chromaticity diagram under a CIE standard light source C, where Rx≧0.65 and Ry≦0.32.

2. The LCD according to claim 1, wherein the white light source is a light-emitting diode (LED).

3. The LCD according to claim 2, wherein the LED comprises a blue diode and a fluorescent powder material distributed on the inner wall of the blue diode.

4. The LCD according to claim 1, wherein a transmittance of the red filter layer in a yellow wave band is substantially smaller than or equal to 40%.

5. The LCD according to claim 4, wherein a wavelength of the yellow wave band is between 585 nm and 605 nm.

6. The LCD according to claim 4, wherein the wavelength of the yellow wave band is 595 nm.

7. The LCD according to claim 1, wherein a transmittance of the red filter layer in a yellow wave band is substantially greater than or equal to 30%.

8. The LCD according to claim 1, wherein the backlight module is a direct or edge type backlight module.

9. The LCD according to claim 1, wherein the composition of the red filter layer comprising three pigments of PR254, PR177, and PY150.

10. The LCD according to claim 1, wherein the LCD is suitable for displaying a red frame, and Ry′ represents a y coordinate of the red frame in the CIE 1931 chromaticity diagram, where Ry′≦0.335.
